(19) United States
(12) Patent Application Publication
(10) Pub. No.: US 2026/0111760 A1
(43) Pub. Date: Apr. 23, 2026

(54) GENERATING AN ARTIFICIAL INTELLIGENCE PROMPT BASED ON EVENT CLASSIFICATION AND ATTRIBUTES

(71) Applicant: MOTOROLA SOLUTIONS, INC., CHICAGO, IL (US)

(72) Inventors: TEJEASH DURAIMANICKAM, LUNAS (MY); ANOOP SEHGAL PARAS RAM, IPOH (MY); WOOI PING TEOH, TANJUNG TOKONG (MY); CHUN WEN OOI, GEORGETOWN (MY)

(21) Appl. No.: 18/922,488

(22) Filed: Oct. 22, 2024

(51) Int. Cl. G06N 5/022

(52) U.S. Cl. CPC G06N 5/022

(57) ABSTRACT

Techniques for generating an artificial intelligence (AI) prompt based on event classification and attributes are provided. An artificial intelligence prompt generator monitors communications between at least two users. An incident is identified based on the communications. An event classifier is identified based on the identified incident. The event classifier is associated with a dataset relevant to the identified incident. Event attributes relevant to the identified event classifier are identified. The event attributes are information needed to characterize the identified event classifier. Portions of the communications between the at least two users responsive to the identified event classifier and the identified event attributes are selected. an AI prompt based on the selected portions is generated. The generated AI prompt is executed by a generative AI model to create the dataset associated with the event classifier.

### BACKGROUND

Public safety officials (e.g. police, fire, emergency medical services, etc.) may be tasked with responding to public safety incidents. Such incidents may include crimes, accidents, fires, medical emergencies, etc. During the response to those incidents, there may be various forms of communication between the public safety officials, who are often referred to as first responders. Those communications can take many different forms, such as text messages, Push-to-Talk communications over a Land Mobile Radio (LMR) system, cellular telephony, or any other type of communication technology.

The content of the communications may allow the first responders to be aware of the status of the incident. For example, in the case of a chemical fire, the type of chemicals involved may be communicated between the first responders. Depending on the incident, the various workflows that are in the process of being executed may be communicated (e.g. evacuation workflow is being executed, etc.).

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is an example system that may implement the generating an artificial intelligence prompt based on event classification and attributes techniques described herein.

FIG. 2 is an example of an AI prompt generator monitoring a conversation between responders to determine event classifiers and attributes to include in a generated prompt according to the techniques described herein.

FIG. 3 is an example of a continuation of the conversation from FIG. 2.

FIG. 4 is an example of a flow diagram for generating a AI prompt according to the techniques described herein.

FIG. 5 is an example of a device that may implement the AI prompt generator described herein.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

In recent years, there have been great advances in the field of Artificial Intelligence (AI). In particular, the field of Generative AI (Gen AI) has made tremendous progress. In a Gen AI system, a prompt is created by the user to initiate the generative process. A prompt is a form of structured input that can be understood by a Gen AI model that has been trained on some corpus of data. For example, the Gen AI model, in a public safety context, may be trained on all available public safety documents (e.g. standard operating procedures, historical incidents and responses, hazardous materials databases, etc.). There are many known Gen AI models (e.g. ChatGPT™, DALL-E, etc.). The techniques described herein are not limited to any particular form of Gen AI model and are usable with any currently existing or later developed model. What should be understood is that a prompt may be generated and sent to a Gen AI to cause the model to generate a response. The response will include the Gen AI's answer to the prompt.

A problem arises in that the quality of the response is dependent on the quality of the prompt that is input into the Gen AI model. The techniques described herein allow for generating prompts based on user's natural conversation. For example, in a public safety context, the user's conversation may be monitored to determine the type of incident to which the users are currently responding. For example, the incident type may be a fire in a building. Using available conversational analytics, it can be determined that the users are discussing a fire incident.

Once an incident type is determined, an event classifier for the incident type may be determined. The event classifier, for example, may indicate various workflows associated with the incident. The workflows may also be referred to as datasets. For example, in the case of a fire incident, event classes could include a safety procedure (e.g. instructing the responders as to how they should proceed, etc.) and an evacuation plan (e.g. how to evacuate people from the location of the fire, etc.).

The creation of the datasets can be accomplished by a Gen AI responding to a generated prompt. However, the quality of the response from the Gen AI may be dependent on the quality of the generated prompt. The techniques described herein may be utilized to generate prompts that provide the Gen AI with sufficient information to generate a detailed dataset (e.g. workflow).

Each classifier within an incident type is associated with a set of attributes for that particular classification. For example, in a fire incident type, the safety procedure classifier may have attributes such as hazardous materials present, material color, chemicals used, etc. The evacuation plan classifier may have attributes such as location of people needing to be evacuated, etc.

In the techniques described herein, an AI prompt generator monitors conversations between responders and/or dispatchers to identify an incident type. The conversation is also monitored to identify classifiers within that incident type. Each of the classifiers is associated with attributes, and the conversation is monitored to identify the presence of those attributes. The AI prompt generator may then generate a prompt based on the classifier and available attributes associated with the classifier.

As the conversation proceeds, the prompt may be modified as new attributes are identified. An indication of how strong the prompt currently is may be presented based on how many attributes are expected for a given classifier vs. how many of those attributes have been determined from the conversation. In some cases, the AI prompt generator may guide the user to ask questions about attributes that have not already been extracted from the conversation.

Once the generated prompt is sufficiently strong, as determined either by the user or by all attributes for the classifier having been satisfied, the generated prompt may then be sent to the Gen AI for execution. The response from the Gen AI will be the dataset (e.g. workflow) that should be used to guide the responder.

A method is provided. The method includes monitoring, with an artificial intelligence (AI) prompt generator, communications between at least two users. The method also includes identifying an incident based on the communications. The method also includes identifying an event classifier based on the identified incident, wherein the event classifier is associated with a dataset relevant to the identified incident. The method also includes identifying event attributes relevant to the identified event classifier, wherein event attributes are information needed to characterize the identified event classifier. The method also includes selecting portions of the communications between the at least two users responsive to the identified event classifier and the identified event attributes. The method also includes generating an AI prompt based on the selected portions. The method also includes executing the generated AI prompt by a generative AI model to create the dataset associated with the event classifier.

In one aspect, the method includes identifying event attributes relevant to the identified event classifier that are not present in the communications between the at least two users and requesting at least one of the at least two users to provide the event attributes that are not present in the communications between the at least two users. In one aspect, the method includes generating a visual indication of a strength of the generated AI prompt based on identified event attributes relevant to the identified event classifier. In one aspect, the method includes receiving approval from the user prior to executing the generated prompt.

A system is provided. The system includes a processor and a memory coupled to the processor. The memory contains a set of instructions thereon that when executed by the processor cause the processor to monitor, with an artificial intelligence (AI) prompt generator, communications between at least two users. The instructions on the memory further cause the processor to identify an incident based on the communications. The instructions on the memory further cause the processor to identify an event classifier based on the identified incident, wherein the event classifier is associated with a dataset relevant to the identified incident. The instructions on the memory further cause the processor to identify event attributes relevant to the identified event classifier, wherein event attributes are information needed to characterize the identified event classifier. The instructions on the memory further cause the processor to select portions of the communications between the at least two users responsive to the identified event classifier and the identified event attributes. The instructions on the memory further cause the processor to generate an AI prompt based on the selected portions. The instructions on the memory further cause the processor to execute the generated AI prompt by a generative AI model to create the dataset associated with the event classifier.

In one aspect, the instructions on the memory further cause the processor to identify event attributes relevant to the identified event classifier that are not present in the communications between the at least two users and request at least one of the at least two users to provide the event attributes that are not present in the communications between the at least two users. In one aspect, the instructions on the memory further cause the processor to generate a visual indication of a strength of the generated AI prompt based on identified event attributes relevant to the identified event classifier. In one aspect, the instructions on the memory further cause the processor to receive approval from the user prior to executing the generated prompt.

A non-transitory processor readable medium containing a set of instructions thereon is provided. The instructions on the medium, that when executed by a processor cause the processor to monitor, with an artificial intelligence (AI) prompt generator, communications between at least two users. The instructions on the medium further cause the processor to identify an incident based on the communications. The instructions on the medium further cause the processor to identify an event classifier based on the identified incident, wherein the event classifier is associated with a dataset relevant to the identified incident. The instructions on the medium further cause the processor to identify event attributes relevant to the identified event classifier, wherein event attributes are information needed to characterize the identified event classifier. The instructions on the medium further cause the processor to select portions of the communications between the at least two users responsive to the identified event classifier and the identified event attributes. The instructions on the medium further cause the processor to generate an AI prompt based on the selected portions. The instructions on the medium further cause the processor to execute the generated AI prompt by a generative AI model to create the dataset associated with the event classifier.

In one aspect, the instructions on the medium further cause the processor to identify event attributes relevant to the identified event classifier that are not present in the communications between the at least two users and request at least one of the at least two users to provide the event attributes that are not present in the communications between the at least two users. In one aspect, the instructions on the medium further cause the processor to generate a visual indication of a strength of the generated AI prompt based on identified event attributes relevant to the identified event classifier. In one aspect, the instructions on the medium further cause the processor to receive approval from the user prior to executing the generated prompt.

In one aspect, the event classifier is at least one of a safety procedure, an evacuation plan, and an Internet of Things (IoT) configuration. In one aspect, the incident is a public safety incident. In one aspect, the at least two users are a dispatcher and a first responder.

Further advantages and features consistent with this disclosure will be set forth in the following detailed description, with reference to the figures.

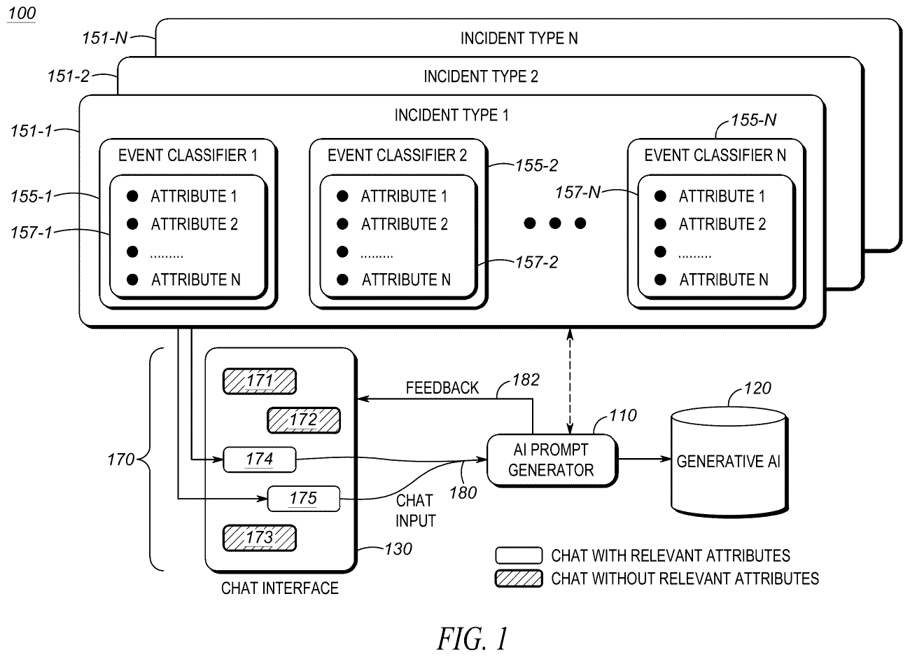

FIG. 1 is an example system 100 that may implement the generating an artificial intelligence prompt based on event classification and attributes techniques described herein. The system includes an AI prompt generator 110, a generative AI 120, and a chat interface 130.

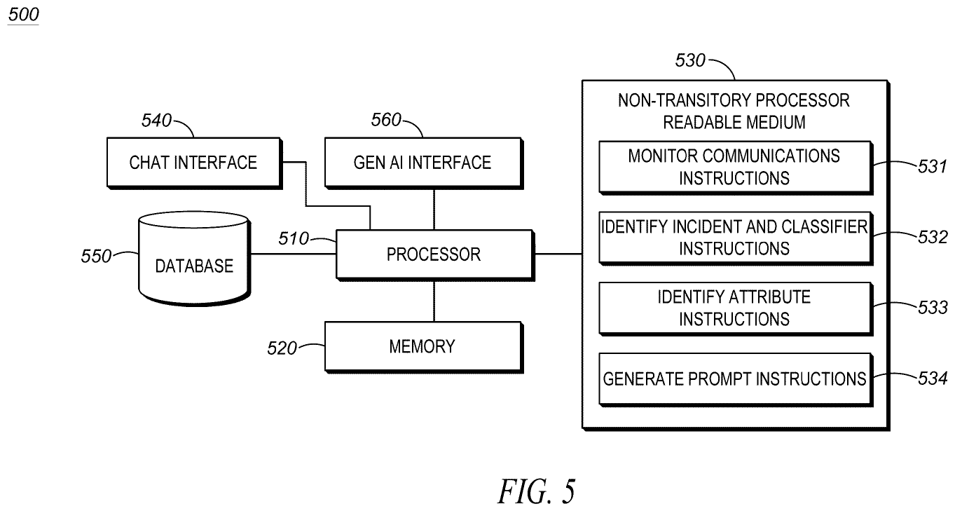

The AI prompt generator 110 may implement the techniques described herein. An example of a device that may implement the AI prompt generator is described with respect to FIG. 5. The AI prompt generator stores information about different incident types 151-1, 2 . . . n. Each incident type is a type of incident that first responders may respond to. For example, as described above, incident types may include vehicle accidents, fires, medical emergencies, etc. The particular type of incident is relatively unimportant, but it should be understood that there are different incident types.

For each incident type, the AI prompt generator 110 stores event classifiers 155-1, 2 . . . n. Although only the event classifiers for one incident type 151-1 is shown, it should be understood that there are event classifiers for each of the incident types 151-1 . . . n. The event classifiers are indicative of the various workflows that may occur for the particular incident type. As described above, event classifiers for a fire incident type may include a safety procedure dataset and an evacuation plan dataset. Other incident types may have different event classifiers. For example, a car accident may include an extract victim event classifier, a tow wreckage event classifier, and an issue citations event classifier. What should be understood is that the event classifier represents the different datasets (e.g. workflows, etc.) that could be executed for a given event classifier. It should also be understood that event classifiers can be different for each possible incident type.

Each event classifier 155-1 . . . n is associated with a set of event attributes 157-1, 2 . . . n. The event attributes 157 are the particular pieces of information needed to generate the prompt that is used by the Gen AI 120 to generate the dataset that will be executed by the responders. In other words, the attributes are those pieces of data that may be included in a prompt to the Gen AI to produce a strong prompt that produces a higher quality response from the Gen AI.

The attributes for each event classifier 155 may overlap. For example, in the case of a fire incident, which has a safety procedure event classifier and an evacuation event classifier, each of those event classifiers may have the common attribute of incident location. In other cases, the event classifier attributes may be different across event classifiers. What should be understood is that each event classifier is associated with a set of attributes and those attributes may or may not overlap across the event classifiers.

The system 100 also includes Generative AI 120. The techniques described herein are not dependent of any particular type of Generative AI and are usable with any currently available or future developed Generative AI that is able to receive a prompt including the event classifiers and event attributes and generate a dataset (e.g. workflow, etc.) based thereon. Training a Generative AI based on domain specific (e.g. public safety, etc.) as well as general corpus of documents (e.g. all documents accessible via the internet, etc.) is known. The techniques described herein are directed to generating prompts based on event classifiers and event attributes, wherein the generated prompt is then executed by a Generative AI to produce a dataset.

The system 100 also includes a chat interface 130. In the example shown, the chat interface is depicted as a text message chat interface, such as text message interface that may appear on a device such as smartphone or tablet. In other implementations, the chat interface may be monitoring a voice conversation between users and utilizing speech to text capabilities to convert the conversation into text. The particular form of the chat interface is relatively unimportant. What should be understood is that the AI prompt generator 110 is able to monitor a conversation between users via the chat interface.

In operation, there may be a conversation 170 occurring between two or more users via the chat interface 130. For example, the users may be using a text-messaging app to communicate. The AI prompt generator 110 may monitor the conversation to identify the type of incident that is being discussed. There are known conversational analytic techniques that can be used to analyze a conversation and determine the type of incident that is being discussed. The techniques described herein are not dependent on any particular technique being used to identify the incident type.

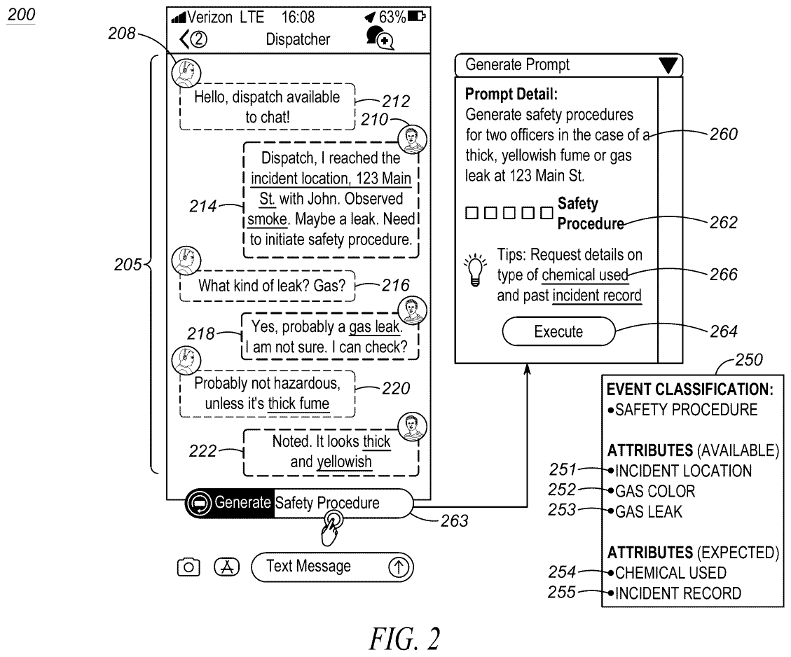

Once an incident type is identified, the event classifiers associated with that incident type can be identified. For the example described with respect to FIG. 1, assume there is only one event classifier associated with the incident type. A more detailed example, with multiple event classifiers, is described with respect to FIG. 2. Once the incident type, and in this example, the singular event classifier is determined, the event attributes for that event classifier are retrieved.

The AI Prompt generator 110 may then monitor the conversation 170 for the presence of the attributes in the conversation. For example, conversation pieces 171, 172, and 173 may be unrelated to the event attributes for the event classifier, and are thus discarded. On the other hand, conversation elements 174 and 175 may map to attributes for this event classifier. For example, if the attribute is an incident location, and the conversation elements 174 and 175 are discussing the incident location, these conversation elements may be included 180 in the prompt generated by the AI prompt generator. In some cases, the AI prompt generator may provide feedback 182 indicating the current strength of the generated prompt as well as providing suggestions for conversation input that may make the generated prompt stronger, and thus more likely to produce a useful response from the Generative AI 120. The AI prompt generator may send the generated prompt to the generative AI for execution to provide a dataset that is usable by the responders to execute the correct workflow. A more detailed example of this process is described with respect to FIG. 2.

FIG. 2 is an example of an AI prompt generator 200 monitoring a conversation between responders to determine event classifiers and attributes to include in a generated prompt according to the techniques described herein.

FIG. 2 depicts a conversation 205 between a dispatcher 208 and a responder 210. Although depicted as a conversation between two people, it should be understood that this is for ease of description only and that the techniques described herein are not so limited. The techniques described herein are suitable for use with any number of conversation participants.

Also, although shown as a conversation being conducted via a text messaging type application, the techniques described herein are not so limited. The conversation could be a voice conversation. The voice conversation could be converted to text using any number of currently available speech-to-text capabilities.

In the present example, the conversation between the dispatcher and the responder may proceed as follows:
Dispatcher: Hello, dispatch available to chat. 212
Responder: Dispatch, I reached the incident location, 123 Main St., with John. Observed Smoke. Maybe a leak. Need to initiate safety procedure. 214
Dispatcher: What kind of leak? Gas? 216
Responder: Yes, probably a gas leak. I am not sure. I can check? 218
Dispatcher: Probably not hazardous, unless it's thick fume. 220
Responder: Noted. It looks thick and yellowish. 222

Using conversational analytics, the AI prompt generator may determine that the incident type is a gas leak. As mentioned above, there are currently available conversational analytics techniques that may be used to identify an incident type from a conversation. In the present example, the presence of the words leak, gas leak, etc. may be used by available conversational analytics to determine the incident type. In some implementations, the incident type may be entered manually. For example, the dispatcher may know the type of incident to which the responder is responding (e.g. the incident is the reason why the responder has been dispatched, etc.). For example, a gas leak incident may have been reported through an emergency phone number, such as 911. What should be understood is that regardless of how determined, there is an incident type associated with the conversation. In the present example, assume the incident type is a gas leak.

As described above, for each incident type, there may be one or more event classifiers.

For ease of description, FIG. 2 is being initially described as being associated with only one event classifier, which is the safety procedure event classification 250. As described above, each event classifier may be associated with one or more event attributes. In the current example, there are five event attributes: 1) incident location 251, 2) gas color 252, 3) gas leak 253, 4) Chemicals used 254, and 5) incident record 255. Initially, all of the event attributes may be listed as “expected” attributes. An expected attribute is an attribute that would be expected for a particular event classifier of an incident type.

The AI prompt generator may monitor the conversation 205 to identify event attributes in the conversation. For example, the incident location 251 attribute can be found in the portion of the conversation 214, where the address of the incident is provided. Likewise, since it is known that the incident type is a leak, the attribute gas leak 253 can be determined from portions of the conversation 216, 218. Similarly, the attribute color 252 can be discerned from conversational element 222, where it is conveyed that the leak detected is thick and yellowish. Attributes that can be extracted from the conversation are shown as available attributes. In other words, all attributes of the event classifier are not available, and are only expected. As the conversation is analyzed, some of the expected attributes are determined and become available attributes.

The AI prompt generator may then generate a prompt 260 that may be sent to the Generative AI to create the dataset associated with the event classifier. The generated prompt may include all event attributes that are currently available from the conversation. For example, prompt 260 may state, “Generate Safety Procedures for two officers in the case of a thick, yellowish fume or gas leak at 123 Main St.” As should be clear, the generated prompt includes all available event attributes for the safety procedure event classifier associated with a leak incident type.

The AI prompt generator may also provide a prompt strength indicator 262 that can display the relative strength of the generated prompt 260. The prompt strength indicator may reflect the number of available attributes in the generated prompt with respect to the total number of expected attributes. The more expected attributes that are available, the stronger the generated prompt. Although depicted as a fuel gauge in FIG. 2, it should be understood that this is only one example of a prompt strength indicator. Any other indicator rendering that can reflect the number of available attributes in relation to the number of expected attributes are suitable for use with the techniques described herein. In some implementations, the strength of the prompt 263 may be displayed within the conversation 205.

The user may be given the option to execute 264 the prompt, regardless of the strength of the prompt. When the prompt is executed, the generated prompt 260 is sent to a generative AI (not shown) for execution. The generative AI executes the prompt and returns a dataset in response to the prompt. The dataset may provide instructions to the responders as to what to do for the specific event classifier.

The AI prompt generator may also provide the user with tips 266 on how the generated prompt can be strengthened/improved. For example, the generated prompt may be the strongest when all expected attributes are also available to be included in the generated prompt. In the present example, the chemical used 254 and incident record 255 are expected attributes that are not currently available from the conversation. As such, the AI prompt generator may suggest that details on the missing expected attributes be provided.

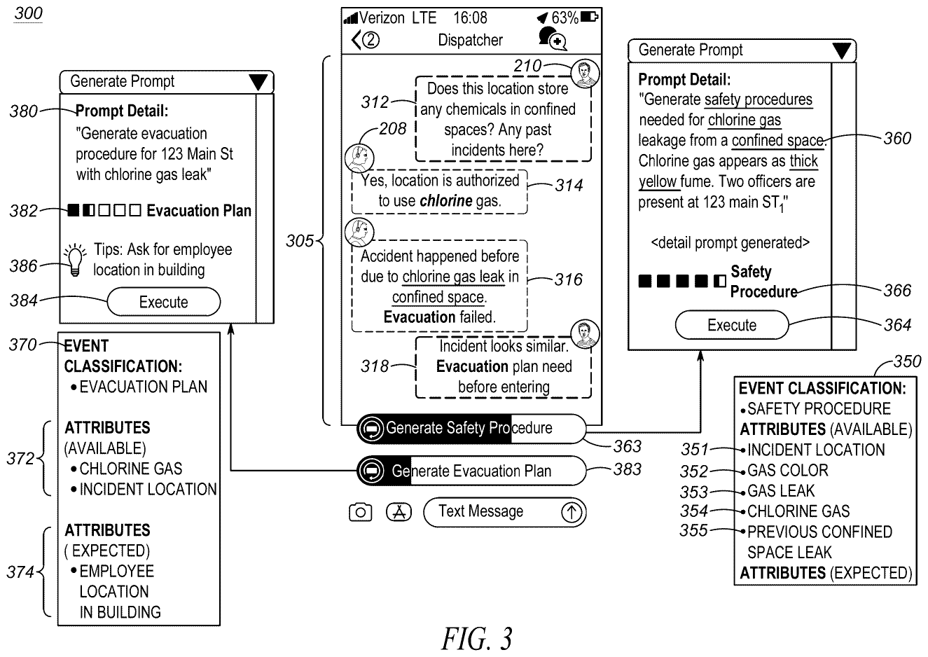

FIG. 3 is an example of a continuation 300 of the conversation from FIG. 2. The continued conversation 305 between the dispatcher 208 and responder 210 may be as follows:
Responder: Does this location store any chemicals in confined spaces? Any past incidents here? 312
Dispatcher: Yes, location is authorized to use chlorine gas. 314
Dispatcher: Accident happened before due to chlorine gas leak in confined space. Evacuation failed. 316
Responder: Incident looks similar. Evacuation plan needed before entering. 318

As mentioned with respect to FIG. 2, the AI prompt generator may provide tips 266 in order to strengthen the prompt. In this example, the responder 210 may follow the tip and ask the dispatcher if the location stores any chemicals in confined spaces and if there have been incidents that have occurred in the past at this location 312. The dispatcher may access databases/historical incident records (not shown) in order to respond to the query. In this case, the response 314, 316 indicates that chlorine gas is authorized for use and there have been previous incidents of leaks of chlorine gas in a confined space.

As described with respect to FIG. 2, attributes for the chemical used 254 and historical incident record 255, are attributes associated with the event classifier that are expected, but were not currently available. When the dispatcher answered the suggested tip question, those attributes are now known. For example, in response 314 it is determine that chlorine gas has been present in the past and this expected attribute 354 is now an available attribute. Likewise, the response 316 shows that there has been a previous incident at this location for a chlorine gas leak in a confined space, which allows the expected incident record attribute 355 to become an available attribute indicating a previous confined space leak has occurred at this location.

As shown in the present example, all attributes 351-355 of the safety procedure event classifier 350 are now available attributes, as they have been extracted from the conversations 205, 305. A prompt 360 may be generated using the available attributes. As shown, the generated prompt may be, “Generate safety procedures needed for chlorine gas leakage from a confined space. Chlorine gas appears as thick, yellow fume. Two officers are present at 123 Main St.”

Because all expected attributes of event classifier 350 are now available attributes that have been included in the AI generated prompt 360, the prompt strength indicator 366 may indicate that the AI generated prompt is very strong. This may also be reflected in the prompt button 363. Just as above, the user may be given the option to execute 364 the AI generated prompt. Execution of the AI generated prompt is described above, and the description will not be repeated here.

In the description of FIG. 2, for ease of description, it was assumed that there was only one event classifier associated with the incident. However, this was for ease of description only and not by way of limitation. For example, as shown in FIG. 3, there may be another event classifier 370 associated with the incident type identified from conversation 318. Just as above, there may be attributes associated with the event classifier. Some of those attributes may be available 372 from the conversations 205, 305. Other attributes may not be available 374.

Just as with respect to event classifier 350, the AI prompt generator may generate a prompt 380 that is based on all currently available attributes. The generated prompt may have a prompt strength indicator 382 which indicates the strength of the prompt given the number of available attributes with respect to the total number of expected attributes. Just as above, the strength of the prompt may be shown within the prompt button 383. AI prompt generator may provide tips 386 to ask questions that may be used to strengthen the generated prompt (e.g. by asking about expected but not yet available attributes, etc.). Just as above the AI prompt generator may allow the user to execute 384 the prompt, regardless of the current strength of the prompt.

Although two possible event classifiers are shown, it should be understood that the techniques described herein are not so limited. For every event classifier associated with an incident type, the conversations are monitored to extract attributes. Those attributes may then be used to generate a prompt that can be sent to a Generative AI to produce and respond with a dataset that indicates the actions to perform for that particular event classifier.

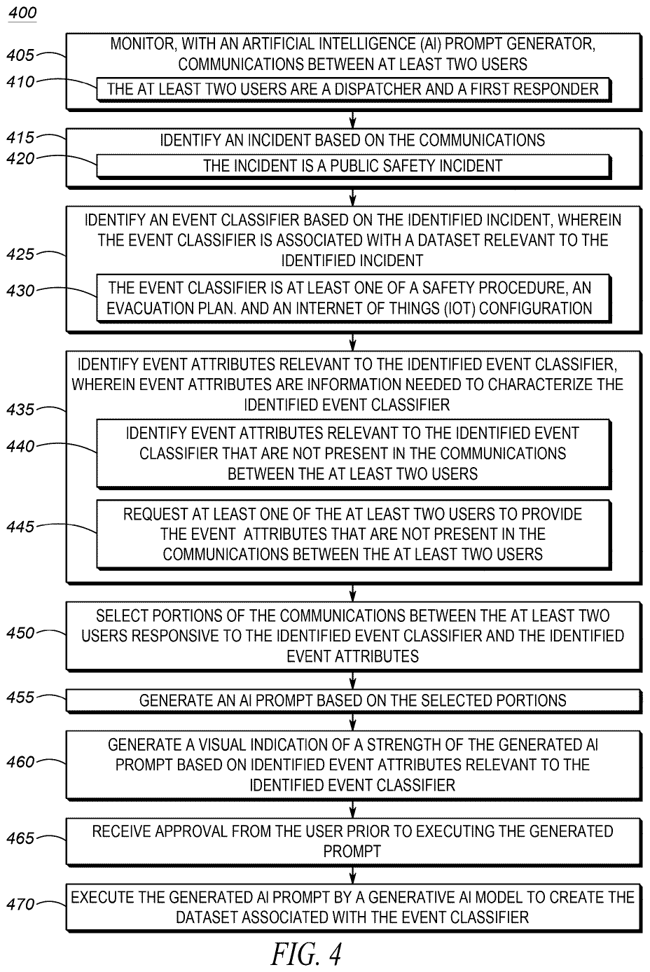

FIG. 4 is an example of a flow diagram 400 for generating an AI prompt according to the techniques described herein. In block 405, an artificial intelligence (AI) prompt generator monitors communications between at least two users. The communications may be in the form of a text message exchange or a voice communication that is converted to text. What should be understood is that the communications are monitored. Furthermore, the communications can occur between two or more users. The techniques described herein are not limited by any number of users participating in the communications. In addition, additional users may be added to the communications in real-time.

In block 410, the at least two users are a dispatcher and a first responder. In a public safety context, a very common paradigm is a dispatcher that receives indications of incidents (e.g. 911 calls, etc.) that then relays the information related to those incidents to first responders in the field that respond to the incidents. In many cases, dispatchers have access to resources (e.g. databases, incident history databases, etc.) that may not be available to the first responders. Thus, responders may ask questions of the dispatcher. Likewise, responders may have access to in-field information that is not available to dispatchers. Thus, dispatchers may also request information from the responder.

In block 415, an incident is identified based on the communication. As explained above, public safety generally responds to incidents, such as crime, fire, medical emergency, etc. There are available conversational analytics that are able to monitor a conversation and determine the type of incident based on the conversation. In other cases, the public safety system itself may assign an incident type manually. For example, when an emergency call is received, the dispatcher may communicate with the caller and identify the type of incident the caller is calling about.

In block 420, the incident is a public safety incident. Although the description has been in terms of a public safety incident, it should be understood that the techniques described herein are not so limited. There are many other situations, such as enterprise situations, that operate using a model similar to a public safety incident model. For example, utilities may operate using a work ticket model, which is similar to an incident. A work ticket may be created by a dispatcher and sent to a worker in the field to respond to the work ticket. The techniques described herein are equally applicable.

In block 425, an event classifier is identified based on the identified incident. The event classifier is associated with a dataset relevant to the identified incident. For each incident type, there may be one or more event classifiers. An event classifier identifies a dataset (e.g. workflow, standard operating procedure, etc.) that is associated with that event classifier. In other words, the event classifier is associated with the workflow that will need to be executed for that particular event class.

In block 430, the event classifier is at least one of a safety procedure, an evacuation plan, and an Internet of Things (IoT) configuration. For example, a safety procedure may be a dataset the informs a responder how to respond to the event class for that incident safely. For example, in the case of a chemical spill, the type of personal protective equipment needed. As should be clear, an evacuation plan may set forth how an incident location should be evacuated. An IoT configuration may specify how a things should be configured (e.g. set HVAC system to off, recall elevators to ground floor, etc.). The specific event classifiers are associated with the incident type. Each incident type may be associated with its own set of event classifiers.

In block 435, event attributes relevant to the identified event classifiers is identified. Event attributes are information needed to characterize the identified event classifier. As explained above, each event classifier is associated with attributes relevant to that particular event classifier and those attributes may be the same or different between different event classifiers. The attributes may be identified by the monitoring of the communications between at least two users, as described above. When an attribute is identified in the conversation, the attribute becomes an available attribute.

In block 440, event attributes that are relevant to the identified classifier that are not present in the communications between the at least two users are identified. In other words, attributes that are expected for the particular event classifier that have not been mentioned in the communications between the at least two users are identified. These missing attributes may cause an AI generated prompt to be less strong as compared to a prompt generated with all expected attributes being available.

In block 445, at least one of the at least two users is requested to provide the event attributes that are not present in the communications between the at least two users. In other words, if there are attributes that are expected for the event classifier that have not been mentioned in the communications between the at least two users, one of the users may be promptly to explicitly ask about the missing attributes. The more expected event attributes that are available attributes, the stronger the AI generated prompt will be.

In block 450, portions of the communications between the at least two users that are responsive to the identified event classifier and identified event attributes are selected. In other words, the parts of the communications between the at least two users that include the expected event attributes for the particular event classifier are identified. Thus, the available event attributes are extracted from the communications.

In block 455, an AI prompt is generated based on the selected portions. As explained above, the selected portions correspond with the available attributes for a given event classifier. Generating a prompt based on these available attributes allows a generative AI to create a dataset responsive to the prompt. The more available attributes, the stronger the generated prompt.

In block 460, a visual indication of the strength of the generated AI prompt is generated based on the identified event attributes relevant to the identified event classifier. As explained above, each event classifier has a set of expected attributes. The more expected attributes that are available, the stronger the AI generated prompt will be. A visual representation of the strength of the prompt is presented to let the user know if execution of the prompt is appropriate or if the prompt should be further developed.

In block 465, approval is received from the user prior to executing the generated prompt. In some cases, if the prompt is not sufficiently strong, the user may wish to defer executing the generated AI prompt until the prompt is stronger (e.g. more expected attributes become available attributes, etc.). Thus the user may be given the option to execute the AI generated prompt now or delay execution to a later time.

In block 470, the generated AI prompt is executed by a generative AI model to create the dataset associated with the event classifier. As mentioned above, the techniques described herein relate to an AI generating a prompt. The particular Generative AI model that executes the prompt is relatively unimportant. What should be understood is the techniques described herein allow for the creation of strong AI generated prompts by monitoring conversations, without requiring the users to manually copy portions of the communications between the users into a manually generated prompt.

FIG. 5 is an example of a device 500 that may implement the AI prompt generator described herein. It should be understood that FIG. 5 represents one example implementation of a computing device that utilizes the techniques described herein. Although only a single processor is shown, it would be readily understood that a person of skill in the art would recognize that distributed implementations are also possible. For example, the various pieces of functionality described above (e.g. communications monitoring, classifier identification, attribute identification, etc.) could be implemented on multiple devices that are communicatively coupled. FIG. 5 is not intended to imply that all the functionality described above must be implemented on a single device.

Device 500 may include processor 510, memory 520, non-transitory processor readable medium 530, chat interface 540, database interface 550, and Gen AI interface 560.

Processor 510 may be coupled to memory 520. Memory 520 may store a set of instructions that when executed by processor 510 cause processor 510 to implement the techniques described herein. Processor 510 may cause memory 520 to load a set of processor executable instructions from non-transitory processor readable medium 530. Non-transitory processor readable medium 530 may contain a set of instructions thereon that when executed by processor 510 cause the processor to implement the various techniques described herein.

For example, medium 530 may include monitor communications instructions 531. The monitor communications instructions 531 may cause the processor to monitor communications between at least two users. For example, the processor may utilize the chat interface 540 to access text or voice communications between users. The monitor communications instructions 531 are described throughout this description generally, including places such as the description of blocks 405 and 410.

The medium 530 may include identify incident and classifier instructions 532. The identify incident and classifier instructions 532 may cause the processor to analyze the communications to identify the incident type that is being discussed as well as identify specific classifiers within that incident type. For example, the processor may access database 550 to retrieve data about the different types of incidents and the classifiers associated with those incident. The identify incident and classifier instructions 532 are described throughout this description generally, including places such as the description of blocks 415-430.

The medium 530 may include identify attribute instructions 533. The identify attribute instructions 533 may cause the processor to extract from the communications between the users attributes associated with the identified incident and classifier. For example, the processor may use the database 550 to determine the attributes that are associated with each classifier associated with an incident. The identify attribute instructions 533 are described throughout this description generally, including places such as the description of blocks 435-445.

The medium 530 may include generate prompt instructions 534. The generate prompt instructions 534 may cause the processor to generate a prompt based on the identified incident, classifier, and attributes. The generate prompt instructions 534 may utilize the Gen AI interface to send the generated prompt to a Gen AI model to execute the generated prompt. The generate prompt instructions 534 are described throughout this description generally, including places such as the description of blocks 450-470.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence.

Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot monitor communications between users to identify an incident, identify a classification, identify attributes associated with the classification, select portions of the communication, and generate an AI prompt based on those portions, using an AI prompt generator, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
monitoring, with an artificial intelligence (AI) prompt generator, communications between at least two users;
identifying an incident based on the communications;
identifying an event classifier based on the identified incident, wherein the event classifier is associated with a dataset relevant to the identified incident;
identifying event attributes relevant to the identified event classifier, wherein event attributes are information needed to characterize the identified event classifier;
selecting portions of the communications between the at least two users responsive to the identified event classifier and the identified event attributes;
generating an AI prompt based on the selected portions;
executing the generated AI prompt by a generative AI model to create the dataset associated with the event classifier.

2. The method of claim 1 further comprising:
identifying event attributes relevant to the identified event classifier that are not present in the communications between the at least two users; and
requesting at least one of the at least two users to provide the event attributes that are not present in the communications between the at least two users.

3. The method of claim 1, wherein the event classifier is at least one of a safety procedure, an evacuation plan, and an Internet of Things (IoT) configuration.

4. The method of claim 1 further comprising:
generating a visual indication of a strength of the generated AI prompt based on identified event attributes relevant to the identified event classifier.

5. The method of claim 1 further comprising:
receiving approval from the user prior to executing the generated prompt.

6. The method of claim 1 wherein the incident is a public safety incident.

7. The method of claim 1 wherein the at least two users are a dispatcher and a first responder.

8. A system comprising:
a processor; and
a memory coupled to the processor, the memory containing a set of instructions thereon that when executed by the processor cause the processor to:
monitor, with an artificial intelligence (AI) prompt generator, communications between at least two users;
identify an incident based on the communications;
identify an event classifier based on the identified incident, wherein the event classifier is associated with a dataset relevant to the identified incident;
identify event attributes relevant to the identified event classifier, wherein event attributes are information needed to characterize the identified event classifier;
select portions of the communications between the at least two users responsive to the identified event classifier and the identified event attributes;
generate an AI prompt based on the selected portions;
execute the generated AI prompt by a generative AI model to create the dataset associated with the event classifier.

9. The system of claim 8 further comprising instructions to:
identify event attributes relevant to the identified event classifier that are not present in the communications between the at least two users; and
request at least one of the at least two users to provide the event attributes that are not present in the communications between the at least two users.

10. The system of claim 8, wherein the event classifier is at least one of a safety procedure, an evacuation plan, and an Internet of Things (IoT) configuration.

11. The system of claim 8 further comprising instructions to:
generate a visual indication of a strength of the generated AI prompt based on identified event attributes relevant to the identified event classifier.

12. The system of claim 8 further comprising instructions to:
receive approval from the user prior to executing the generated prompt.

13. The system of claim 8 wherein the incident is a public safety incident.

14. The system of claim 8 wherein the at least two users are a dispatcher and a first responder.

15. A non-transitory processor readable medium containing a set of instructions thereon that when executed by a processor cause the processor to:
monitor, with an artificial intelligence (AI) prompt generator, communications between at least two users;
identify an incident based on the communications;
identify an event classifier based on the identified incident, wherein the event classifier is associated with a dataset relevant to the identified incident;
identify event attributes relevant to the identified event classifier, wherein event attributes are information needed to characterize the identified event classifier;
select portions of the communications between the at least two users responsive to the identified event classifier and the identified event attributes;
generate an AI prompt based on the selected portions;
execute the generated AI prompt by a generative AI model to create the dataset associated with the event classifier.

16. The medium of claim 15 further comprising instructions to:
identify event attributes relevant to the identified event classifier that are not present in the communications between the at least two users; and
request at least one of the at least two users to provide the event attributes that are not present in the communications between the at least two users.

17. The medium of claim 15, wherein the event classifier is at least one of a safety procedure, an evacuation plan, and an Internet of Things (IoT) configuration.

18. The medium of claim 15 further comprising instructions to:
generate a visual indication of a strength of the generated AI prompt based on identified event attributes relevant to the identified event classifier.

19. The medium of claim 15 further comprising instructions to:
receive approval from the user prior to executing the generated prompt.

20. The medium of claim 15 wherein the incident is a public safety incident.
